(19) United States
(12) Patent Application Publication
(10) Pub. No.: US 2025/0055191 A1
(43) Pub. Date: Feb. 13, 2025

(54) DUAL-BAND ANTENNA AND ELECTRONIC DEVICE

(71) Applicant: GUANGDONG COROS SPORTS TECHNOLOGY CO., LTD, Dongguan (CN)

(72) Inventors: Zhimin QIAN, Dongguan (CN); Xianwei SHI, Dongguan (CN)

(21) Appl. No.: 18/795,297

(22) Filed: Aug. 6, 2024

(30) Foreign Application Priority Data
Aug. 10, 2023 (CN) 202311010815.3

(51) Int. Cl. H01Q 5/50; H01Q 1/48; H01Q 5/10

(52) U.S. Cl. CPC H01Q 5/50; H01Q 1/48; H01Q 5/10

(57) ABSTRACT

A dual-band antenna includes a radiator, a feed apparatus, and a first tuning module. The radiator includes a radiator element. The feed apparatus includes a feed point. The radiator element is electrically connected to the feed apparatus through the feed point. The first tuning module is electrically connected to the radiator element and configured to receive a first signal of a first frequency and a second signal of a second frequency. An effective length of the radiator element is 1/4 of a wavelength corresponding to a frequency between the first frequency and the second frequency.

### CROSS-REFERENCE TO RELATED APPLICATION

The present disclosure claims priority to Chinese Patent Application No. 202311010815.3, filed Aug. 10, 2023, the entire content of which is incorporated herein by reference.

### TECHNICAL FIELD

The present disclosure generally relates to the antenna technology in the antenna field and, more particularly, to a dual-band antenna and an electronic device.

### BACKGROUND

A satellite positioning antenna in an electronic device is very important for the satellite positioning performance of the electronic device. In the existing technology, a satellite positioning antenna typically includes two segments of positioning antennas. Each segment positioning antenna receives a positioning signal of a corresponding frequency band. Then, based on the received positioning signals of two frequency bands, the electronic device is positioned. However, in the existing technology, the structure of the satellite positioning antenna is complex and occupies a large space.

### SUMMARY

In accordance with the disclosure, there is provided a dual-band antenna, including a radiator, a feed apparatus, and a first tuning module. The radiator includes a radiator element. The feed apparatus includes a feed point. The radiator element is electrically connected to the feed apparatus through the feed point. The first tuning module is electrically connected to the radiator element and configured to receive a first signal of a first frequency and a second signal of a second frequency. An effective length of the radiator element is ¼ of a wavelength corresponding to a frequency between the first frequency and the second frequency.

In accordance with the disclosure, there is provided an electronic device, including a housing, a dual-band antenna, and a position determination apparatus. The housing includes a bottom wall and a sidewall connected to the bottom wall. The dual-band antenna is arranged at the sidewall and includes a radiator, a feed apparatus, and a first tuning module. The radiator includes a radiator element. The feed apparatus includes a feed point. The radiator element is electrically connected to the feed apparatus through the feed point. The first tuning module is electrically connected to the radiator element and configured to receive a first signal of a first frequency and a second signal of a second frequency. The position determination apparatus is coupled with the dual-band antenna and configured to receive the first signal and the second signal and determine a current geographic location of the electronic device according to the first signal and the second signal. An effective length of the radiator element is ¼ of a wavelength corresponding to a frequency between the first frequency and the second frequency.

### BRIEF DESCRIPTION OF THE DRAWINGS

FIG. 1 is a schematic structural diagram of a dual-band antenna according to some embodiments of the present disclosure.

FIG. 2 is a schematic structural diagram of another dual-band antenna according to some embodiments of the present disclosure.

FIG. 3 is a schematic structural diagram of another dual-band antenna according to some embodiments of the present disclosure.

FIG. 4 is a schematic structural diagram of another dual-band antenna according to some embodiments of the present disclosure.

FIG. 5 is a schematic diagram showing a gain of a positioning signal of 1.6 GHZ according to some embodiments of the present disclosure.

FIG. 6 is a schematic diagram showing a gain of a positioning signal of 1.2 GHZ according to some embodiments of the present disclosure.

FIG. 7 is a schematic diagram showing a wave return loss when two positioning signals with different frequencies are received according to some embodiments of the present disclosure.

FIG. 8 is a schematic structural diagram of an electronic device according to some embodiments of the present disclosure.

FIG. 9 is a schematic top view of an electronic device according to some embodiments of the present disclosure.

FIG. 10 is a schematic diagram showing return wave loss when two positioning signals with different frequencies and two communication signals are received according to some embodiments of the present disclosure.

FIG. 11 is a schematic top view of another electronic device according to some embodiments of the present disclosure.

FIG. 12 is another schematic diagram showing return wave loss when two positioning signals with different frequencies and two communication signals are received according to some embodiments of the present disclosure

### REFERENCE NUMERALS

| | | |
|---|---|---|
| 100 Dual-band antenna | 110 Radiator | 111 First radiator |
| | | element |
| 112 Second radiator | 120 Feed apparatus | 130 First tuning module |
| element | | |
| 140 Feed point | 150 Second tuning | |
| | module | |
| 160 Third tuning | 200 Electronic | 210 Position |
| module | device | determination apparatus |
| 220 Bottom wall | 230 Sidewall | |

### DETAILED DESCRIPTION OF THE EMBODIMENTS

The technical solutions of embodiments of the present disclosure are described in detail in connection with the accompanying drawings of embodiments of the present disclosure.

Described embodiments are merely used to explain not limit the present disclosure.

Embodiments of the present disclosure provide a dual-band antenna 100. As shown in FIG. 1, the dual-band antenna 100 includes a radiator 110, a feed apparatus 120, and a first tuning module 130.

The radiator 110 includes a first radiator element 111. The radiator 110 includes a feed point 140. The first radiator element 111 is electrically connected to the feed apparatus 120 through the feed point 140.

The first radiator element 111 is electrically connected to the first tuning module 130 and is configured to receive a first signal of a first frequency and a second signal of a second frequency.

An effective length of the first radiator element 111 is ¼ of a wavelength corresponding to a frequency between the first frequency and the second frequency.

In some embodiments, the first radiator element 111 can be a conductor. The material of the first radiator element 111 can determine the radiation characteristic and the frequency characteristic of the first radiator element 111.

In some embodiments, the material of the first radiator element 111 can be metal. Metal can have good electrical conductivity and thermal conductivity. The radiation efficiency and impedance matching performance of the metal first radiator element 111 can be better than the radiation efficiency and the impedance matching performance of the first radiator element 111 with other materials. In some embodiments, the metal can include at least one of copper, aluminum, or steel.

In some embodiments, the material of the first radiator element 111 can include plastic and a metal coating. In some embodiments, Laser Direct Structuring (LDS) technology can be used to engrave laser circuits on the plastic to obtain the first radiator element 111.

In some embodiments, the material of the first radiator element 111 can include a ceramic substrate and a metal coating. In some embodiments, a metal coating can be printed on the surface of the ceramic substrate to obtain the first radiator element 111. The material of the metal coating can be silver.

The material of the first radiator element 111 can be flexibly chosen according to actual application scenarios. The material of the first radiator element 111 is not limited by embodiments of the present disclosure.

In embodiments of the present disclosure, the radiator 110 can include a feed point 140. The first radiator element 111 can be electrically connected to the feed apparatus 120 through the feed point 140 to transmit and receive a wireless signal. The position of the feed point 140 can be flexibly set according to actual application scenarios. In embodiments of the present disclosure, the position of the feed point 140 at the radiator 110 is not limited.

The first radiator element 111 can be electrically connected to the first tuning module 130. The effective length of the first radiator element 111 can be 1/4 of the wavelength corresponding to the frequency between the first frequency and the second frequency to receive the first signal of the first frequency and the second signal of the second frequency. The first signal and the second signal can be sent by the satellite or the base station. The first frequency can be different from the second frequency. The first signal and the second signal can be positioning signals used for positioning.

The length of the first radiator element 111 can be set based on the first frequency of the first signal and the second frequency of the second signal to ensure the signal strengths of the received first signal and the second signal to further improve the signal reception effect of the dual-band antenna 100.

The effective length can be the length of a part of the first radiator element 111 used to receive a wireless signal.

In some embodiments, the effective length of the first radiator element 111 can be calculated through the following formula (1)

$$L = ( 1 / 4 ) λ = c / ( 4 f ) \qquad ( 1 )$$

where “L” denotes the effective length of the first radiator element 111, λ denotes the wavelength corresponding to a frequency between the first frequency and the second frequency, “f” denotes any frequency between the first frequency and the second frequency, and “c” denotes the speed of light.

In embodiments of the present disclosure, the first radiator element 111 can be electrically connected to the feed apparatus 120 via the feed point 140 and can receive a wireless signal. Then, the first tuning module 130 can perform tuning processing on the wireless signal to obtain the first signal of the first frequency and the second signal of the second frequency. Thus, through the electrical connection between the first radiator element 111 and the first tuning module 130, and the effective length of the first radiator element 111 being 1/4 of the wavelength corresponding to the frequency between the first frequency and the second frequency, the two signals of different frequencies can be received. The two segments of antennas may not need to be set independently to receive the two signals of different frequencies. Thus, the mutual interference between the two segments of antennas can be prevented from impacting the performance of the antenna.

The first signal can be a first positioning signal, and the second signal can be a second positioning signal.

In some embodiments, the first radiator element 111 can be electrically connected to the feed apparatus 120 via the feed point 140 and can receive a wireless signal. Then, the first tuning module 130 can perform a tuning process on the wireless signal to obtain the first signal of the first frequency and the second signal of the second frequency.

In some embodiments, the first radiator element 111 can be electrically connected to the feed apparatus 120 via the feed point 140 and can receive two wireless signals. The first tuning module 130 can then determine the first wireless signal with a frequency close to the first frequency and the second wireless signal with a frequency close to the second frequency from the two wireless signals. Then, the first wireless signal can be tuned to obtain the first signal of the first frequency, and the second wireless signal can be tuned to obtain the second signal of the second frequency.

In some embodiments, the first signal of the first frequency can be a satellite positioning signal of L1 frequency in the GPS frequency band. The second signal of the second frequency can be a satellite positioning signal of L5 frequency in the GPS frequency band. L1 frequency can be 1.6 GHz, and L5 frequency can be 1.2 GHz.

The dual-band antenna 100 can also include a position determination apparatus 210. The position determination apparatus 210 can also be arranged in the electronic device where the dual-band antenna 100 is. The position determination apparatus 210 can determine the current geographic location of the electronic device based on the first signal and the second signal.

In some embodiments, the electronic device can be a wearable device or a mobile phone. The wearable device can include one of a smart helmet, smart glasses, a smart mask, a smart watch, a smart wristband, and smart shoes.

The first radiator element 111 can also be connected to a ground terminal for impedance tuning. Thus, the dual-band antenna 100 can receive the first signal and the second signal with optimal performance.

The dual-band antenna of the present disclosure can include the radiator, the feed apparatus, and the first tuning module. The radiator can include the first radiator element 111, and the radiator can include the feed point. The first radiator element can be electrically connected to the feed apparatus via the feed point. The first radiator element can be electrically connected to the first tuning module and can be configured to receive the first signal of the first frequency and the second signal of the second frequency. The effective length of the first radiator element can be 1/4 of the wavelength corresponding to the frequency between the first frequency and the second frequency. Thus, by electrically connecting the first radiator element to the first tuning module and with the effective length of the first radiator element being 1/4 of the wavelength corresponding to the frequency between the first frequency and the second frequency, two signals with different frequencies can be received without arranging two first radiator elements with different lengths separately to receive the two signals of different frequencies, which simplifies the internal structure of the dual-band antenna and reduces the complexity of the dual-band antenna. Then, the space occupied by the dual-band antenna can be further reduced in the electronic device.

Based on the above, embodiments of the present disclosure provide the dual-band antenna 100. As shown in FIG. 1, the dual-band antenna 100 includes the radiator 110, the feed apparatus 120, and the first tuning module 130.

The radiator 110 can include the first radiator element 111 and the feed point 140. The first radiator element 111 can be electrically connected to the feed apparatus 120 through the feed point 140.

The first radiator element 111 can be electrically connected to the first tuning module 130 and can be configured to receive the first signal of the first frequency and the second signal of the second frequency.

The effective length of the first radiator element 111 can be 1/4 of the wavelength corresponding to the frequency between the first frequency and the second frequency.

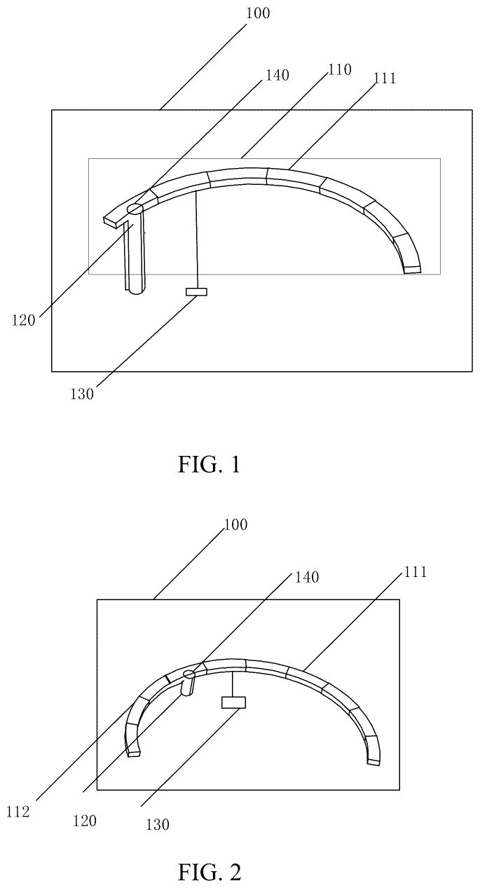

As shown in FIG. 2, the radiator further includes a second radiator element 112. The second radiator element 112 is connected to the first radiator element 111. The types of signals received by the first radiator element 111 and the second radiator element 112 can be different. The second radiator element 112 can be a conductor with electrical conductivity.

In some other embodiments of the present disclosure, the material of the second radiator element 112 and the material of the first radiator element 111 can be the same or different. The length of the first radiator element 111 and the length of the second radiator element 112 can be different.

The second radiator element 112 can at least receive a signal. The signal received by the second radiator element 112 can be a communication signal. The signal received by the first radiator element 111 can be a positioning signal. Thus, through the first radiator element 111 and the second radiator element 112, different types of signals can be received to cause the dual-band antenna 100 to be used in a positioning scenario and a communication scenario.

The shape of the radiator can be an arc segment. The shape of the First radiator element 111 and the shape of the second radiator element 112 can be an arc segment.

In some embodiments, when the electronic device is a circular smartwatch, the shape of the radiator can be an arc segment. Thus, with the original structure of the electronic device, the dual-band antenna 100 can be integrated at the sidewall of the electronic device. Then, the dual-band antenna 100 can be applied to the electronic device with a small size. Thus, the dual-band antenna 100 can be integrated into the electronic device without reconstructing the internal structure of the electronic device, which reduces the cost and lowers the structural complexity of the electronic device.

In other embodiments of the present disclosure, the second radiator element 112 can be configured to receive a WIFI signal and/or a Bluetooth signal.

The communication signal can include a Wireless-Fidelity (WIFI) signal and/or a Bluetooth signal.

When the second radiator element 112 is only configured to receive the WIFI signal, the length of the second radiator element 112 can be 1/4 of the wavelength corresponding to a third frequency of the WIFI signal.

When the second radiator element 112 is only configured to receive the Bluetooth signal, the length of the second radiator element 112 can be 1/4 of the wavelength corresponding to a fourth frequency of the Bluetooth signal.

When the second radiator element 112 needs to receive the WIFI signal and the Bluetooth signal, the length of the second radiator element 112 can be 1/4 of the wavelength corresponding to the third frequency of the WIFI signal or the fourth frequency of the Bluetooth signal. The third frequency and the fourth frequency can be the same.

Thus, the length of the second radiator element 112 can be set according to the frequency of the signal that needs to be received by the second radiator element 112 to ensure the signal strength of the signal received by the second radiator element 112 to further improve the signal reception effect of the second radiator element 112.

In other embodiments of the present disclosure, as shown in FIG. 2, the shape of the radiator is an arc segment.

The shape of the radiator can be a minor arc segment or a major arc segment.

As shown in FIG. 2, the shape of the radiator is the arc segment. When the shape of the radiator is a minor arc segment, the shape of the first radiator element 111 and the shape of the second radiator element 112 can be minor arc segments. When the shape of the radiator is a major arc segment, the shape of the first radiator element 111 and the shape of the second radiator element 112 can be minor arc segments, or the shape of the first radiator element 111 can be a minor arc segment and the shape of the second radiator element 112 can be a major arc segment, or the shape of the first radiator element 111 can be a major arc segment and the shape of the second radiator element 112 can be a minor arc segment.

In the existing technology, by setting two different separate positioning antenna segments to receive the first signal of the first frequency and the second signal of the second frequency, and setting a communication antenna segment to receive the communication signal, that is, at least three separate antenna segments can be set to receive the positioning signal and the communication signal. However, in the technical solution of the present disclosure, two positioning signals with different frequencies and the communication signal can be received by the radiator of one arc segment. Thus, the structure of the antenna can be simplified, and the size of the antenna can be reduced, which facilitates integrating the antenna into the electronic device. Thus, the antenna can be integrated into the electronic device with a small size. Moreover, the interference of separately setting different positioning antennas can be avoided, the performance of the antenna can be optimized, and the positioning performance of the electronic device can be further improved.

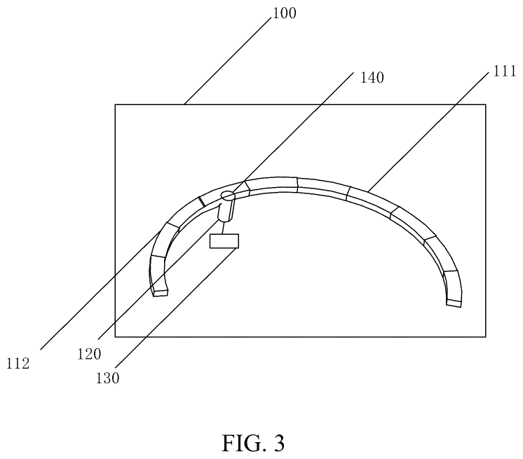

In other embodiments of the present disclosure, as shown in FIG. 3, the first radiator element 111 is connected to the first tuning module 130 through the feed apparatus 120.

The first tuning module 130 can include a first tuning apparatus.

In some embodiments, the first tuning apparatus can include a capacitor and/or an inductor.

In some embodiments, as shown in FIG. 3, the first radiator element 111 is connected to the feed apparatus 120 via the feed point 140 and configured to receive at least one wireless signal. The tuning processing can be performed on the wireless signal by the first tuning module 130 to obtain the first positioning signal of the first frequency and the second positioning signal of the second frequency. Thus, by connecting the first tuning module 130 to the feed apparatus 120, the first tuning module 130 can promptly process the received wireless signal to obtain the first positioning signal and the second positioning signal. Thus, the speed of receiving the first positioning signal and the second positioning signal by the dual-band antenna 100 can be improved. The first frequency can be 1.2 GHz, and the second frequency can be 1.6 GHz.

In some embodiments, the frequency of the received wireless signal can be 1.4 GHz. The first tuning module 130 can perform the tuning processing on the wireless signal to obtain the first positioning signal of 1.2 GHz and the second positioning signal of 1.6 GHz.

In some other embodiments, two wireless signals can be received with frequencies of 1.4 GHz and 1.8 GHz, respectively. The first tuning module 130 can be configured to perform tuning processing on the wireless signal of 1.4 GHz to obtain the first positioning signal of 1.2 GHz and on the wireless signal of 1.8 GHz to obtain the second positioning signal of 1.6 GHz.

In other embodiments of the present disclosure, the dual-band antenna 100 can further include a second tuning module 150 and/or a third tuning module 160.

The second tuning module 150 can be connected to an end of the first radiator element 111.

The third tuning module 160 can be connected to the first radiator element 111 through a ground terminal.

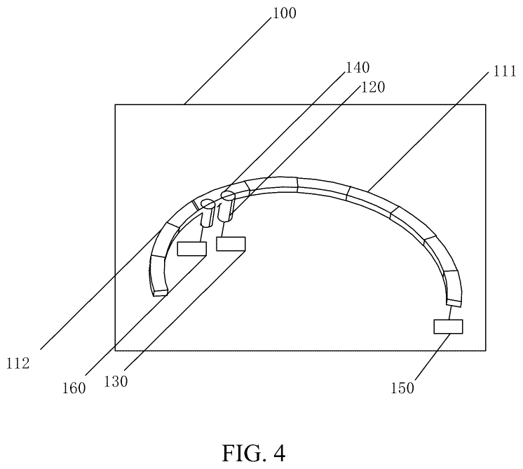

As shown in FIG. 4, the shape of the radiator is an arc segment. The dual-band antenna 100 further includes the second tuning module 150 and the third tuning module 160.

The second tuning module 150 is connected to an end of the first radiator element 111. The third tuning module 160 is connected to the first radiator element 111 through a ground terminal. The second tuning module 150 includes a second tuning apparatus for aperture tuning. The aperture tuning can be used to improve the efficiency of the antenna. The third tuning module 160 includes a third tuning apparatus for impedance tuning.

In some embodiments, the second tuning apparatus can include at least one of an aperture tuner, a parallel capacitor (to lower the resonant frequency), or a parallel inductor (to increase the resonant frequency). By connecting the second tuning apparatus to an end of the first radiator element 111, the operation frequency band of the antenna can be tuned, and the efficiency of the antenna can be improved.

In some embodiments, an end of the ground terminal can be connected to the first radiator element 111, and another end of the ground terminal can be connected to the third tuning apparatus for impedance tuning. Thus, the dual-band antenna 100 can have maximum radiation power at any frequency to reduce the loss caused by impedance mismatch to cause the dual-band antenna 100 to receive the first signal and the second signal with the optimal performance. The third tuning apparatus can include an antenna tuner.

In other embodiments of the present disclosure, the size of the radiator can be reduced while ensuring the effective length of the first radiator element 111 as 1/4 of the wavelength corresponding to the frequency between the first frequency and the second frequency to reduce the size of the dual-band antenna 100. Thus, the space occupied by the dual-band antenna 100 when integrated into the electronic device can be reduced.

In addition, the position of the feed point 140 on the first radiator element 111 can be flexibly adjusted to adjust the reception effect of the first signal and the second signal.

In the related technology, two separate radiators can be configured to receive positioning signals of corresponding frequencies, respectively. However, when the two radiators are rotated, respectively, to adjust the position of the feed point to ensure the reception effects of the first positioning signal and the second positioning signal, the positions of the two radiators can overlap with each other. Thus, the reception effect of only one positioning signal can be ensured, and the reception effect of the other positioning signal cannot be ensured. Therefore, the reception effects of the two positioning signals can have a large difference, which reduces the positioning accuracy of the two positioning signals, which is described in detail in connection with the accompanying drawings.

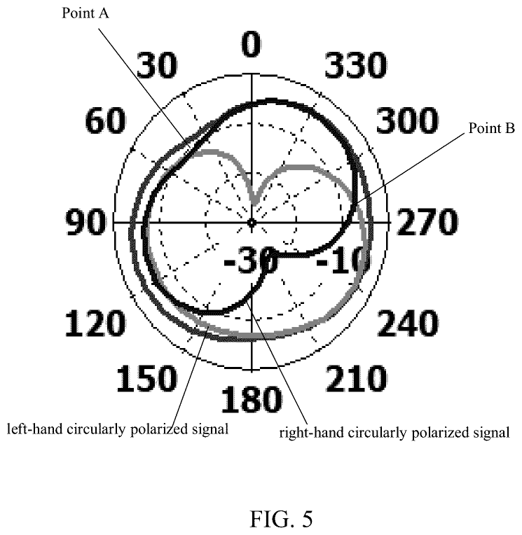

FIG. 5 is a schematic diagram showing a gain of a positioning signal of 1.6 GHZ according to some embodiments of the present disclosure. When the reception effect of the positioning signal of 1.6 GHZ is ensured, the antenna may need to ensure that the reception effect of a right-hand circularly polarized signal is better than the reception effect of a left-hand circularly polarized signal. Thus, as shown in FIG. 5, the orientation of the feed point 140 needs to be adjusted to a direction between 40 degrees west of north (point A) and 80 degrees east of north (point B).

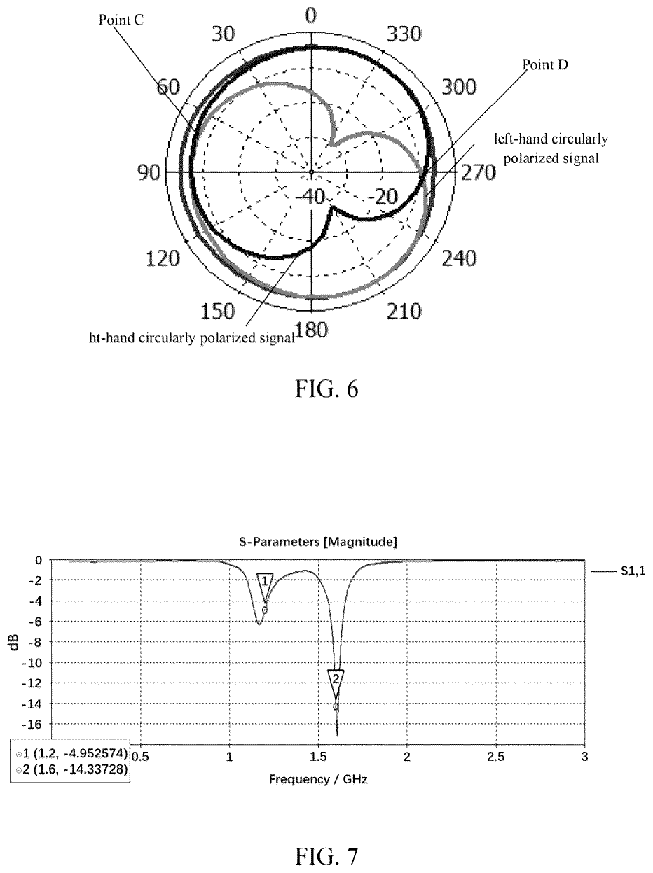

FIG. 6 is a schematic diagram showing a gain of a positioning signal of 1.2 GHZ according to some embodiments of the present disclosure. When the reception effect of the positioning signal of 1.2 GHZ is ensured, the antenna may need to ensure that the reception effect of a right-hand circularly polarized signal is better than the reception effect of a left-hand circularly polarized signal. Thus, as shown in FIG. 6, the orientation of the feed point 140 needs to be adjusted to a direction between 70 degrees west of north (point C) and 90 degrees east of north (point D).

According to FIGS. 5 and 6, the reception effects of the positioning signal of 1.6 GHZ and the positioning signal of 1.2 GHZ needs to be ensured simultaneously. In the related technology, the two radiators can be rotated to adjust the position of the feed point 140, and the positions of the two radiators can overlap with each other, which can not ensure the reception effects of the positioning signal of 1.6 GHZ and the positioning signal of 1.2 GHZ simultaneously. As shown in FIG. 7, the wave return losses of receiving the two positioning signals are quite different from each other. Thus, the reception effect of only one positioning signal can be ensured. As shown in FIG. 7, the reception effect of the positioning signal of 1.6 GHZ is better than the reception effect of the positioning signal of 1.2 GHZ. The reception effects of the two positioning signals are quite different, and the reception effects of the two positioning signals cannot be ensured simultaneously.

However, in embodiments of the present disclosure, through the first radiator element 111, the position of the feed point 140 can be adjusted to the direction between 40 degrees west of north (point A) and 80 degrees east of north (point B) to simultaneously ensuring the reception effects of the positioning signal of 1.6 GHZ and the positioning signal of 1.2 GHZ to optimally receive the positioning signal of 1.6 GHZ and the positioning signal of 1.2 GHZ.

For the same content, reference can be made to the description of other embodiments of the present disclosure, which is not repeated.

Embodiments of the present disclosure provide the dual-band antenna. By electrically connecting the first radiator element to a first tuning module and with the effective length of the first radiator element being 1/4 of the wavelength corresponding to the frequency between the first frequency and the second frequency, two signals with different frequencies can be received, which simplifies the internal structure of the dual-band antenna and reduces the complexity of the dual-band antenna. Thus, the space occupied by the dual-band antenna arranged in the electronic device can be further reduced. Moreover, the shape of the radiator can be an arc segment, which reduces the size of the dual-band antenna. With the original structure of the electronic device, the dual-band antenna can be integrated inside the electronic device. Thus, without reconstructing the internal structure of the electronic device, the dual-band antenna can be integrated inside the electronic device, which saves the cost.

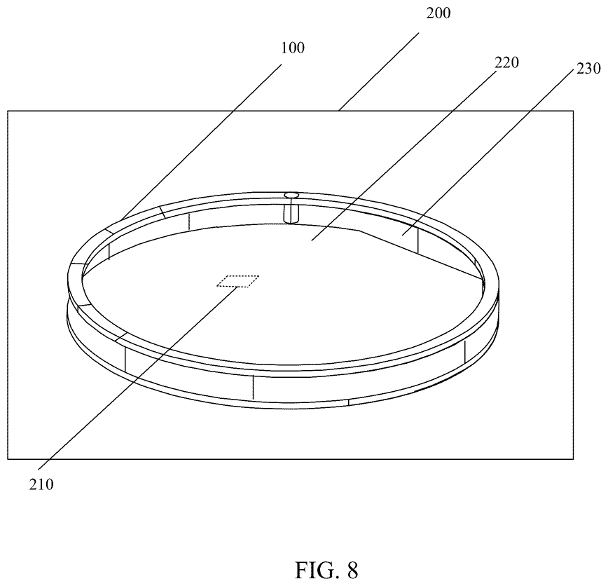

Based on the above, embodiments of the present disclosure provide an electronic device. As shown in FIG. 8, the electronic device 200 includes a housing, a position determination apparatus 210, and the above dual-band antenna 100. The housing includes a bottom wall 220 and a sidewall 230 connected to the bottom wall 220. The dual-band antenna 100 is arranged at the sidewall 230.

The position determination apparatus 210 is electrically coupled with the dual-band antenna 100 and is configured to receive the first signal and the second signal and determine the current geographical location of the electronic device 200 according to the first signal and the second signal.

By arranging the dual-band antenna 100 at the sidewall 230, the space occupied by the dual-band antenna 100 in the electronic device 200 can be reduced, and the internal space utilization rate of the electronic device 200 can be improved.

By adjusting the position of the feed point 140 at the bottom wall 220, the reception performance of the dual-band antenna 100 can be improved when the electronic device 200 is in a certain scenario. Since the structure of the dual-band antenna 100 is simple, the dual-band antenna 100 can be integrated inside the electronic device 200 to reduce the cost and facilitate subsequent maintenance.

In some other embodiments of the present disclosure, the electronic device 200 can be a wearable device or a terminal device.

In some embodiments, the wearable device can include one of a smart helmet, smart glasses, a smart mask, a smartwatch, a smart wristband, and smart shoes. The terminal device can be a cellphone.

In some other embodiments, as shown in FIG. 8, the position determination apparatus 210 is integrated in the bottom wall 220.

When the shape of the radiator 110 of the dual-band antenna 100 is an arc segment, the whole annular sidewall 230 may not need to be occupied. The size of the electronic device 200 can be made smaller to improve the portable performance of the electronic device 200.

For the description of the same content, reference can be made to the description of other embodiments of the present disclosure, which is not repeated here.

Embodiments of the present disclosure provide an electronic device. The electronic device can include the housing, the position determination apparatus, and the dual-band antenna. The housing can include the bottom wall and the sidewall connected to the bottom wall. The dual-band antenna can be arranged at the sidewall. The position determination apparatus can be coupled with the dual-band antenna and configured to receive the first signal and the second signal. According to the first signal and the second signal, the current geographical location of the electronic device can be determined. Thus, only by connecting the first radiator element to the first tuning module, and with the effective length of the first radiator element being 1/4 of the wavelength corresponding to the frequency between the first frequency and the second frequency, the first signal and the second signal can be received. Thus, without separately arranging the two radiators in the dual-band antenna, the first signal and the second signal can be received, which reduces the complexity of the dual-band antenna and reduces the size of the dual-band antenna. When the dual-band antenna is integrated into the electronic device, the space occupied by the dual-band antenna in the electronic device can also be reduced.

Based on the above, in some other embodiments of the present disclosure, as shown in FIG. 8, the electronic device 200 includes a housing, a position determination apparatus 210, and the above dual-band antenna 100. The housing includes a bottom wall 220 and a sidewall 230 connected to the bottom wall 220. The dual-band antenna 100 is arranged at the sidewall 230.

The position determination apparatus 210 can be electrically coupled with the dual-band antenna 100 and can be configured to receive the first signal and the second signal and determine the current geographic position of the electronic device 200 according to the first signal and the second signal.

In other embodiments of the present disclosure, the feed point 140 can be arranged in a 7 to 9 o'clock direction or 9 to 11 o'clock direction of the bottom wall 220.

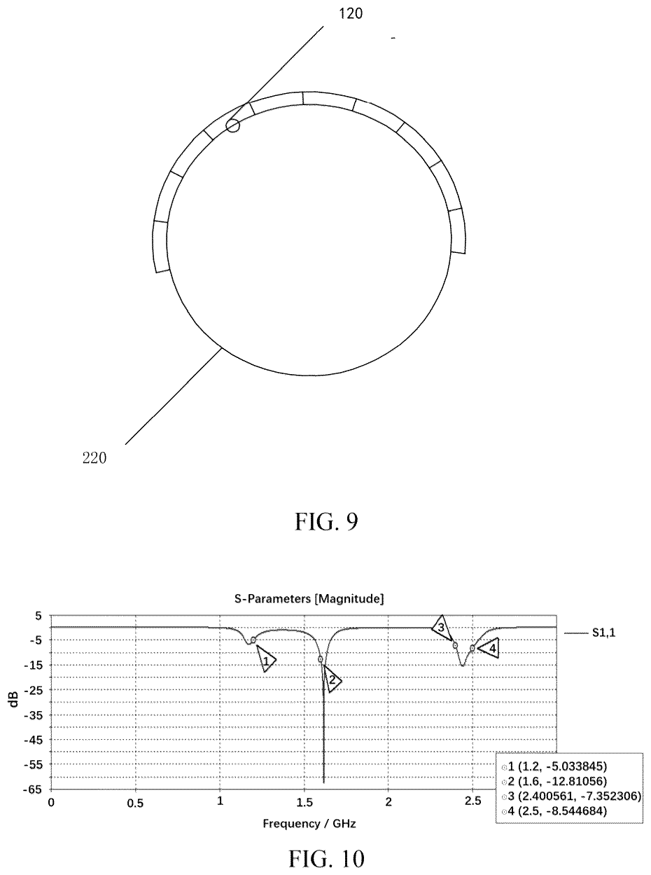

In some embodiments, as shown in FIG. 9, the shape of the radiator of the dual-band antenna 100 is an arc segment. The feed point 140 is in the 11 o'clock direction at the bottom wall 220. When the feed point 140 is in the 11 o'clock direction at the bottom wall 220, as shown in FIG. 10, the wave return losses of the positioning signal of 1.2 GHZ and the positioning signal of 1.6 GHZ can be similar. That is, the reception effects of the positioning signal of 1.2 GHZ and the positioning signal of 1.6 GHZ can be similar. Thus, the reception effects of the two positioning signals of different frequencies can be ensured. The radiator can include the second radiator element 112. As shown in FIG. 10, when the position of the feed point 140 relative to the bottom wall 220 is adjusted, the reception effects of the second radiator element 112 receiving the two communication signals are also ensured. The position pointed by arrow 1 can represent the positioning signal of 1.2 GHZ. The position pointed by arrow 2 can represent the positioning signal of 1.6 GHZ. The position pointed by arrow 3 can represent the Bluetooth signal. The position pointed by arrow 4 can represent the WIFI signal.

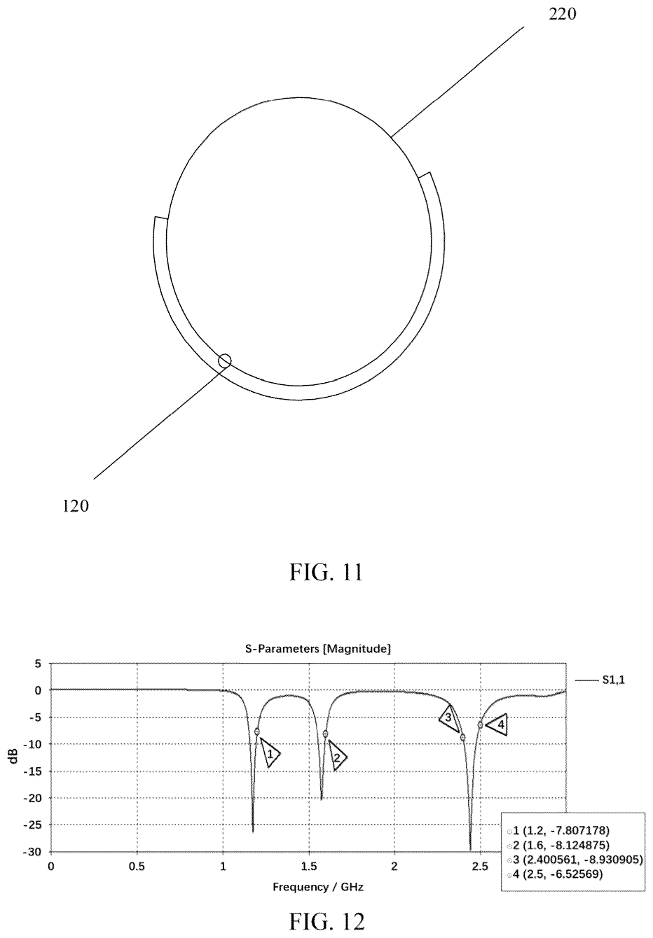

In some embodiments, as shown in FIG. 11, the shape of the radiator of the dual-band antenna 100 is an arc segment, and the feed point 140 is in the 7 o'clock direction at the bottom wall 220. When the feed point 140 is at the 7 o'clock direction at the bottom wall 220, as shown in FIG. 12, the wave return losses of the position signal of 1.2 GHZ and the positioning signal of 1.6 GHZ are similar. That is, the reception effects of the positioning signal of 1.2 GHZ and the positioning signal of 1.6 GHZ are similar. Thus, the reception effects of the two positioning signals with different frequencies can be ensured. As shown in FIG. 12, the radiator includes the second radiator element 112. When the position of the feed point 140 relative to the bottom wall 220 is adjusted, the effects of the second radiator element 112 receiving two communication signals can be also ensured. The position pointed by arrow 1 can represent the positioning signal of 1.2 GHZ. The position pointed by arrow 2 can represent the positioning signal of 1.6 GHZ. The position pointed by arrow 3 can represent the Bluetooth signal. The position pointed by arrow 4 can represent the WIFI signal.

The dual-band antenna 100 can be a monopole antenna, an inverted-F antenna (IFA), a loop antenna, or other types of antennas. In practical applications, the type of dual-band antenna can be flexibly set according to the application scenario. The type of dual-band antenna of embodiments of the present disclosure is not limited.

In the description of the present disclosure, the description with reference to terms such as “certain embodiments,” “one embodiment,” “some embodiments,” “illustrative embodiments,” “examples,” “specific examples,” “some examples,” or “other embodiments of the application” is intended to represent that specific features, structures, materials, or characteristics described in connection with embodiments or examples can be included in at least one embodiment or example of the present disclosure. In the present disclosure, the illustrative description of the terms may not necessarily represent the same embodiment or example, the described specific features, structures, materials, or characteristics can be combined in an appropriate manner in one or more embodiments or examples.

In the description of the present disclosure, unless otherwise explicitly specified and limited, terms such as “connected” or “coupled” should be understood in a broad sense, e.g., including fixed connections, detachable connections, or integral connections, mechanical connections, electrical connections, or communicative connections, or direct connections or indirect connections through intermediate media, internal communication within two elements, or interactive relationship between two elements. Those ordinary skills in the art can understand the specific meaning of the terms in the present disclosure according to actual situations.

In addition, the terms “first” and “second” are merely used for descriptive purposes and should not be understood as indicating or implying relative importance or implicitly specifying the number of technical features indicated. Thus, features defined with “first” and “second” may explicitly or implicitly include at least one feature. In the description of the present disclosure, “a plurality of” means at least two, such as two, three, etc., unless otherwise explicitly specified.

The terms “include,” “comprise,” or any other variants thereof are intended to cover non-exclusive inclusion, so that a process, method, item, or apparatus that includes a series of elements not only includes those elements but also other elements not explicitly listed, or other elements inherent to such process, method, item, or apparatus. Without further limitation, an element defined by the phrase “including a . . . ” does not exclude the presence of additional identical elements within the process, method, item, or apparatus that includes the element.

The numbers of embodiments of the present disclosure are provided merely for descriptive purposes and do not represent the merits of embodiments of the present disclosure.

Through the description of embodiments of the present disclosure, those skilled in the art can clearly understand that the above method of embodiments of the present disclosure can be implemented using software with a necessary general-purpose hardware platform, or though hardware alone. However, normally, implementing the method using software with the necessary general-purpose hardware platform can be a better embodiment. Based on this understanding, the essence of a part of the technical solution of the present disclosure contributing to the existing technology can be embedded in the form of a software product. The computer software product can be stored in a storage medium (e.g., ROM/RAM, magnetic disc, and optical disc). The computer software product can include several instructions used to cause one terminal device (e.g., the cellphone, the computer, the server, the AC, or the network apparatus) to perform the method described in embodiments of the present disclosure.

The above are some embodiments of the present disclosure and do not limit the patent scope of the present disclosure. The equivalent structure or equivalent process change made according to the specification and accompanying drawings of the present disclosure can be applied in other related technical fields. The technical field can be within the scope of the present disclosure.

What is claimed is:

1. A dual-band antenna comprising:
a radiator including a radiator element,
a feed apparatus including a feed point, the radiator element being electrically connected to the feed apparatus through the feed point, and
a first tuning module electrically connected to the radiator element and configured to receive a first signal of a first frequency and a second signal of a second frequency;
wherein an effective length of the radiator element is ¼ of a wavelength corresponding to a frequency between the first frequency and the second frequency.

2. The antenna according to claim 1, wherein the first signal is a first positioning signal, and the second signal is a second positioning signal.

3. The antenna according to claim 2, wherein:
the radiator element is a first radiator element; and
the radiator further includes a second radiator element connected to the first radiator element, signals received by the first radiator element and the second radiator element having different types.

4. The antenna according to claim 3, wherein the second radiator element is configured to receive a WIFI signal and/or a Bluetooth signal.

5. The antenna according to claim 4, wherein a shape of the radiator is an arc segment.

6. The antenna according to claim 1, wherein the radiator element is connected to the first tuning module via the feed apparatus.

7. The antenna according to claim 6, further comprising:
a second tuning module connected to an end of the radiator element; and/or
a third tuning module connected to the radiator element via a ground terminal.

8. An electronic device comprising:
a housing including a bottom wall and a sidewall connected to the bottom wall;
a dual-band antenna arranged at the sidewall and including
a radiator including a radiator element;
a feed apparatus including a feed point, the radiator element being electrically connected to the feed apparatus through the feed point, and
a first tuning module electrically connected to the radiator element and configured to receive a first signal of a first frequency and a second signal of a second frequency; and
a position determination apparatus coupled with the dual-band antenna and configured to receive the first signal and the second signal and determine a current geographic location of the electronic device according to the first signal and the second signal;
wherein an effective length of the radiator element is ¼ of a wavelength corresponding to a frequency between the first frequency and the second frequency.

9. The device according to claim 8, wherein the feed point is in a 7 to 9 o'clock direction or a 9 to 11 o'clock direction at the bottom wall.

10. The device according to claim 8, wherein the first signal is a first positioning signal, and the second signal is a second positioning signal.

11. The device according to claim 10, wherein
the radiator element is a first radiator element; and
the radiator further includes a second radiator element connected to the first radiator element, signals received by the first radiator element and the second radiator element having different types.

12. The device according to claim 11, wherein the second radiator element is configured to receive a WIFI signal and/or a Bluetooth signal.

13. The device according to claim 12, wherein a shape of the radiator is an arc segment.

14. The device according to claim 8, wherein the radiator element is connected to the first tuning module via the feed apparatus.

15. The device according to claim 14, wherein the dual-band antenna further includes:
a second tuning module connected to an end of the radiator element; and/or
a third tuning module connected to the radiator element via a ground terminal.
